(19) United States
(12) Patent Application Publication
(10) Pub. No.: US 2009/0262986 A1
(43) Pub. Date: Oct. 22, 2009

(54) GESTURE RECOGNITION FROM CO-ORDINATE DATA

(75) Inventors: Luke Cartey, Hungerford (GB); Martin J. Rowe, Chandlers Ford (GB); Thomas Gummery, Saffron Walden (GB); Jenna Goldstein, Bognor Regis (GB); Ben Organ, Caldicot (GB)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/107,432

(22) Filed: Apr. 22, 2008

(51) Int. Cl. G06K 9/00

(52) U.S. Cl. 382/107

(57) ABSTRACT

A method for gesture recognition may comprise: a) receiving a first plurality of coordinates defining a first position of a limb from an image capture device; b) mapping at least one of the first plurality of coordinates to a cell; c) generating a first list of cells including cells to which the at least one coordinate of the first plurality of coordinates is mapped; d) receiving a second plurality of coordinates defining a second position of a limb from an image capture device; e) mapping at least one coordinate of the second plurality of coordinates to a cell; f) generating a second list of cells including cells to which the at least one coordinate of the second plurality of coordinates is mapped; g) defining an avatar gesture comprising a sequence of at least the first list of cells and the second list of cells; h) receiving a sample sequence of coordinates defining a plurality of positions of a limb from an image capture device; i) mapping the sample sequence of coordinates to a sample sequence of cells; and j) pattern-matching at least a portion of the sample sequence of cells and an avatar gesture of a plurality of avatar gesture.

### BACKGROUND

Current motion capture technologies are capable of producing a list of limb co-ordinates, but these are currently unusable for any technologies with a limited control over avatar movements. An interlinked problem is that of interpreting gestures made by a real life person as an “action” for the computer—in other words, not only using interpretation for mimicking of movements on to avatars, but also as an input device. In many virtual worlds, the avatars can only be controlled in a limited way—for example, by “replaying” a previously saved animation. As such, it may be desirable to provide a method to map coordinate data for a particular limb's movements into an abstract action, such as “point” or a “clap”.

### SUMMARY

A solution is required which may allow the presenter to make a wide range of natural gestures, and have those translated and mapped, in a best-fit manner, onto a smaller set of limited gestures.

An extension of the template pattern of gesture analysis is provided. A histogram may be used to represent a particular gesture. This model may represent gestures as a sequence of cells. This sequence of cells may then be used to perform real-time analysis on data from a motion capture or other input device.

For example, the 2D or 3D space around a user may be divided into a series of regions, called “cells.” A series of common gestures, as a list of cells, which are persistently stored can then be defined. This is then used to interpret incoming co-ordinates into abstract “actions.”

One of the advantages of the cell-based recognition is that it will map a very wide range of gestures of a similar nature into a single, perhaps more appropriate or obvious, abstract action. This action may take the form of an abstract definition of a gesture, such as “point right”, or a description of an action, such as “jump”. Such abstract definitions may operate to “smooth” the image capture data, particularly for scenarios where it may be best to simply take a “best-fit” estimation of the data. The method also works in a time agnostic fashion—a quick or a slow gesture will still be interpreted correctly. Similarly, the density of the data points is, to a certain degree, irrelevant.

This model may be based purely on a template system (unlike the Hidden Markov Model or Neural Network based solutions, which are trained probabilistically to identify the gesture). It differs from the current template systems in the way it stores and represents the raw data of gestures—using vector quantization style techniques to smooth the data.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is an example of a cell layout; and

FIG. 2 is an example of a gesture path.

### DETAILED DESCRIPTION

Reference will now be made in detail to the subject matter disclosed, which is illustrated in the accompanying drawings.

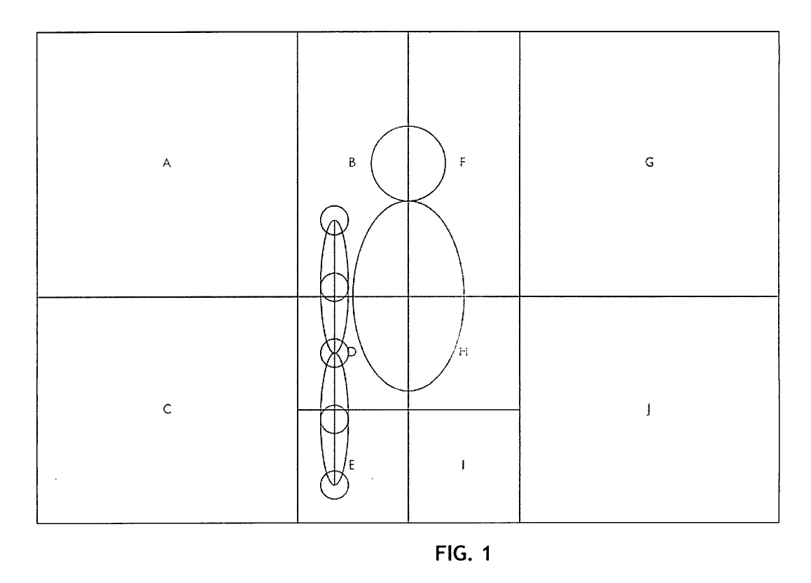

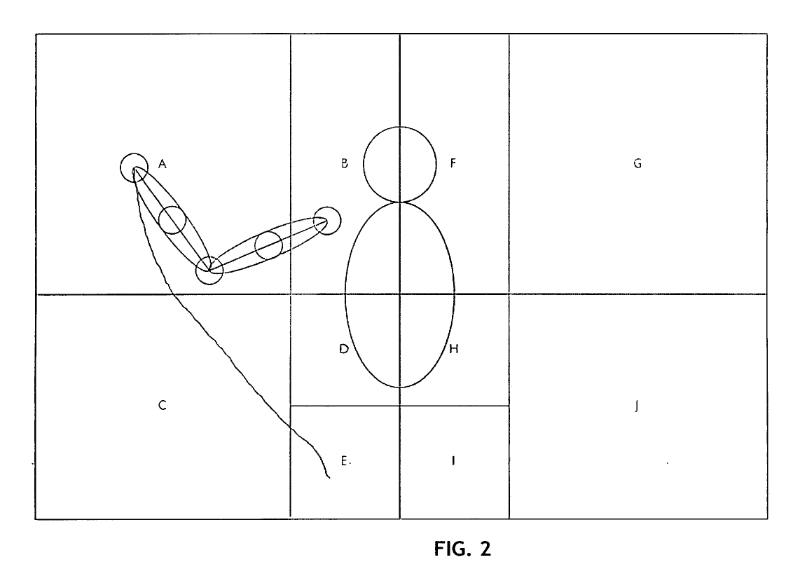

Referring to FIGS. 1 and 2, the space around a user may be mapped into a series of regions, called “cells” (e.g. cells A-J). Data regarding a particular limb may be received as a stream of co-ordinates (for example, from a motion capture device) and mapped to the cells. These cells can be defined in a number of ways (e.g. vector quantization, fixed co-ordinates). Whatever method is used, each co-ordinate may be mapped to a particular cell. Any duplicate cells that are adjacent to each other may be dynamically removed. Once complete, a list of cells that represent the co-ordinates of position of the limb is produced.

A number of “gestures” may be stored within the system (e.g. a list of abstract actions combined with the sequence of cells which represent them). Conversely, these gestures may be combined with the list of cells taken obtained from co-ordinate data to produce a list of abstract actions.

A stream of cells may be interpreted through continual analysis. At each point, a given time period (e.g. four seconds) worth of cell-data (hereafter known as a “sample”) may be considered and pattern-matched with the collection of pre-defined gestures. This may be done by looking for each gesture sequence inside the sample. The gesture sequence may not be required to be sequential (e.g. gesture sequence cells may be separated by intervening cells). Cells defined in a gesture may be effectively treated as “key frames” (e.g. cells that must be reached by the sample in order to correlate to a given gesture). The broadest possible gesture (e.g. the gesture having the highest correlation to the sample and covering the greatest time span in the sample) may be selected for use as the avatar interpretation of a gesture.

More advanced configuration of gestures may be applied to further define factors that will facilitate a more accurately interpreted a sample.

For example, a temporal distance between cells of a gesture and cell of a sample may indicate a decreasing probability of a match between the gesture and the sample.

Further, a list of allowable cell paths within a gesture may be defined. If a cell outside of the defined path is detected in a sample, it may indicate a decreased probability of a match between the gesture and the sample.

Further, required timings for the presence of a particular cell for a gesture may be defined. For example, for a “pointing right” gesture, it may be useful to define that a certain percentage of the sample must include a given cell (e.g. a cell located within a top corner).

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method comprising:
receiving a first plurality of coordinates defining a first position of a limb from an image capture device;
mapping at least one of the first plurality of coordinates to a cell;
generating a first list of cells including cells to which the at least one coordinate of the first plurality of coordinates is mapped;
receiving a second plurality of coordinates defining a second position of a limb from an image capture device;
mapping at least one coordinate of the second plurality of coordinates to a cell;
generating a second list of cells including cells to which the at least one coordinate of the second plurality of coordinates is mapped;
defining an avatar gesture comprising a sequence of at least the first list of cells and the second list of cells;
receiving a sample sequence of coordinates defining a plurality of positions of a limb from an image capture device;
mapping the sample sequence of coordinates to a sample sequence of cells; and
pattern-matching at least a portion of the sample sequence of cells and an avatar gesture of a plurality of avatar gesture.

2. The method of claim 1, further comprising:
selecting an avatar gesture from of a plurality of avatar gestures having the highest degree of pattern-matching to the sample sequence of cells over the greatest period of time.

3. The method of claim 1, wherein the cell is defined by vector quantization.

4. The method of claim 1, wherein the cell is defined by fixed coordinates.

5. The method of claim 1, further comprising:
removing duplicate cells from at least one of the first list of cells and the second list of cells.

6. The method of claim 1, further comprising:
calculating a temporal difference between a cell of an avatar gesture and a cell of a sample sequence of cells; and
selecting an avatar gesture from a plurality of avatar gestures according to the temporal difference.

7. The method of claim 1, further comprising:
defining allowable cell paths for an avatar gesture;
selecting an avatar gesture as an interpretation of the sample sequence of cells only if the cell paths of the sample sequence of cells contains only allowed cell paths.

8. The method of claim 1, further comprising:
defining a required duration of presence of a cell in an avatar gesture;
selecting an avatar gesture as an interpretation of the sample sequence of cells only if the cell path of the sample sequence of contains the cell having the required duration of presence.
